(19) United States
(12) Patent Application Publication
(10) Pub. No.: US 2023/0264653 A1
(43) Pub. Date: Aug. 24, 2023

(54) USER AUTHENTICATION

(71) Applicant: Motional AD LLC, Boston, MA (US)

(72) Inventors: Alexander Steinwald, Boston, MA (US); Peter Leeman, Pittsburgh, PA (US); Moira Doherty, Charlestown, MA (US); Christopher Konopka, Peabody, MA (US); Sean Beaudette, Pittsburgh, PA (US); Maksym Bruner, Singapore (SG)

(21) Appl. No.: 18/173,540

(22) Filed: Feb. 23, 2023

Related U.S. Application Data
(60) Provisional application No. 63/313,368, filed on Feb. 24, 2022.

(51) Int. Cl. B60R 25/24; B60R 25/01; G07C 9/00

(52) U.S. Cl. CPC B60R 25/24; B60R 25/01; G07C 9/00309; B60R 2325/20; G07C 2009/00769

(57) ABSTRACT

A system includes a verification engine communicatively coupled to a sensing device and a database, the verification engine receives first authentication data, retrieves, from the database, second authentication data associated with a stored vehicle identifier to compare the vehicle identifier to the stored vehicle identifier to determine whether the vehicle identifier matches the stored vehicle identifier. In a case the vehicle identifier matches the stored vehicle identifier the user device is authenticated and access to the vehicle is provided.

### CROSS-REFERENCE TO RELATED APPLICATION

This application claims the benefit of priority from U.S. Patent Application No. 63/313,368, filed on Feb. 24, 2022, and entitled, “USER AUTHENTICATION,” the contents of which are hereby fully incorporated by reference.

### BACKGROUND

An autonomous vehicle is capable of sensing its surrounding environment and navigating without human input. Upon receiving data representing the environment and/or any other parameters, the vehicle performs processing of the data to determine its subsequent decisions. The decisions may be intended to provide an ability to safely navigate the vehicle along a selected path, allow access to the vehicle, and/or perform any other functions.

### BRIEF DESCRIPTION OF THE FIGURES

FIG. 1 is an example environment in which a vehicle including one or more components of an autonomous system can be implemented;

FIG. 2 is a diagram of one or more systems of a vehicle including an autonomous system;

FIG. 3 is a diagram of components of one or more devices and/or one or more systems of FIGS. 1 and 2;

FIG. 4A is a diagram of certain components of an autonomous system;

FIG. 4B is a diagram of an implementation of a neural network;

FIGS. 4C and 4D are a diagram illustrating example operation of a CNN;

FIG. 5 illustrates an example of a system for authenticating a user, according to some embodiments of the current subject matter;

FIG. 6 is a flow chart illustrating an example of a backend process for performing user authentication, according to some embodiments of the current subject matter;

FIGS. 7A-7G illustrate examples of frontend (e.g., when a user is at the vehicle) processes for authenticating the user, according to some embodiments of the current subject matter;

FIG. 8 illustrates an example process 800 for authenticating a user, according to some embodiments of the current subject matter.

### DETAILED DESCRIPTION

In the following description, numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

General Overview

A vehicle (e.g., an autonomous vehicle) includes sensors that monitor various parameters associated with the vehicle. For example, some sensors (e.g., cameras, LIDAR sensors, RADAR sensors, SONAR sensors, etc.) monitor/detect changes occurring in the vehicle's environment (e.g., actions and/or presence of other vehicles, pedestrians, street lights, etc.). The information/data received from the sensors is used by the vehicle's controller (or any other processing component) to determine various subsequent actions that can be performed by the vehicle. These include, but are not limited to, determination of a path of travel, direction, speed, and/other movement parameters, allowing/restricting access to the vehicle's compartments (e.g., unlocking/locking one or more doors, unlocking/locking a trunk, unlocking/locking one or more selected vehicle's compartments, etc.), requesting additional data, etc.

In some embodiments, the current subject matter system is configured to perform authentication of a user of an autonomous vehicle, such as, for example, for the purposes of unlocking/locking of one or more vehicle's compartments (e.g., trunk, doors, etc.), executing a motion maneuver, etc. The vehicle may be equipped with one or more sensing devices (e.g., existing cameras, motion sensors, QR code scanners/readers, etc.) that can be configured to detect, receive, read, etc. various data that can be presented to them. The data can include an authentication data that can be associated with a particular user (e.g., a QR (quick response) code, a PIN (Personal Identification Number) code, etc.).

User authentication is necessary in autonomous vehicles (e.g., taxi, delivery, etc.) to ensure that only authorized users are gaining access to the vehicle. Conventional systems require users to use a mobile application to gain access to vehicles, where users, upon requesting a vehicle, use the application for authentication in order to unlock the vehicle (e.g., “swipe to unlock” applications). However, in many instances, users might not have a mobile device that may be used for authentication purposes, or have an appropriate mobile application that can be used for authentication. One such example includes deliveries, where merchants and/or merchant delivery personnel typically are not expected to have an application on their mobile devices that can be used for authentication (e.g., “swipe to unlock”) and thus, would be prevented from accessing a locked autonomous vehicle for placement of items for delivery to customers.

In exemplary, non-limiting, embodiments, where the user is a delivery merchant, such data can be a QR code that can incorporate an order number corresponding to an order placed by a customer of the merchant. The QR code can also include a vehicle identification information corresponding to a particular vehicle selected or assigned by the merchant for delivery of the customer order. The data/information obtained from the scanned QR code (or any other data) can be transmitted to an external database that stores vehicle identification data/information for a plurality of vehicles to determine whether the transmitted data/information matches data/information stored in the database and associated with the merchant-selected/assigned vehicle. If there is a match, the vehicle can receive a signal that can cause it to perform various actions (e.g., unlock trunk, unlock doors, start the vehicle, etc.). Otherwise, if no match is found, an error can be generated and can prevent the user from accessing the vehicle and/or prompting the user to perform the above process (e.g., re-authenticate) again.

In some embodiments, one or more processors (e.g., vehicle's arbitration unit, controller, etc.) detect a first authentication data (e.g., QR code, pin code, etc.) associated with a user. The processors also determine a second authentication data identifying a vehicle (e.g., vehicle identifier, etc.) and compare it to the first authentication data to determine whether at least one portion (e.g., vehicle's identifier) included in the first authentication data matches the second authentication data. Upon determining that at least one portion of the first authentication data matches the second authentication data, the processors authenticate the user and execute at least one action associated with operation of the vehicle (e.g., cause the vehicle to unlock the doors, unlock trunk, execute one motion maneuver, etc.). Otherwise, upon determining that the above portion of the first authentication data does not match the second authentication data, the processors prevent authentication of the user as well as execution of any actions associated with operation of the vehicle.

In some embodiments, the first authentication data is detected using at least one sensing device positioned on the vehicle. The sensing device(s) include at least one of the following: a camera, a motion sensor, an image capturing device, a scanner, a QR code scanner, a keypad sensing device, and any combination thereof.

In some embodiments, the first authentication data is provided by the user using at least one user device.

In some embodiments, the second authentication data is stored in at least one database storing a plurality of second authentication data. Each second authentication data in the plurality of second authentication data identifies a respective vehicle. The database is communicatively coupled to one or more processors.

In some embodiments, the second authentication data is designated (e.g., by the delivery merchant) as being assigned to the first authentication data prior to performing detection of the first authentication data.

In some embodiments, the detection of the first authentication data includes scanning, using at least one sensing device positioned on the vehicle, for the first authentication data. The detection of the first authentication data also includes receiving, using at least one sensing device positioned on the vehicle, an entry of the first authentication data. Moreover, the detection includes providing the second authentication data using at least one user device.

In some embodiments, at least one action that can be executed includes at least one of the following: unlocking at least one compartment of the vehicle, locking at least one compartment of the vehicle, executing at least one motion maneuver by the vehicle, and any combination thereof. Further, the motion maneuver includes determining at least one: a speed, a position, an acceleration, a direction of movement, a travel destination, and any combination thereof of the vehicle.

By virtue of the implementation of systems, methods, and computer program products described herein, techniques for authenticating a user ensure that only authorized users can gain access to the autonomous vehicle, whereby authentication may be performed with or without any additional computing components (e.g., a mobile device having a designated application for unlocking the vehicle and/or confirming identity of the user). Such authentication processes may be helpful in delivery scenarios where a user (e.g., a delivery merchant, a customer, etc.) might not have a mobile device or an application for accessing the vehicle. Moreover, existing autonomous vehicle's sensors (e.g., cameras, motion sensors, etc.) may be used for the purposes of authenticating the user.

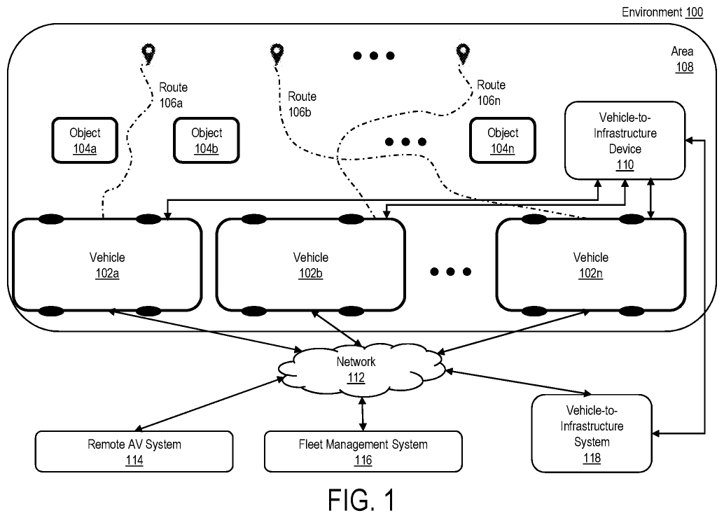

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

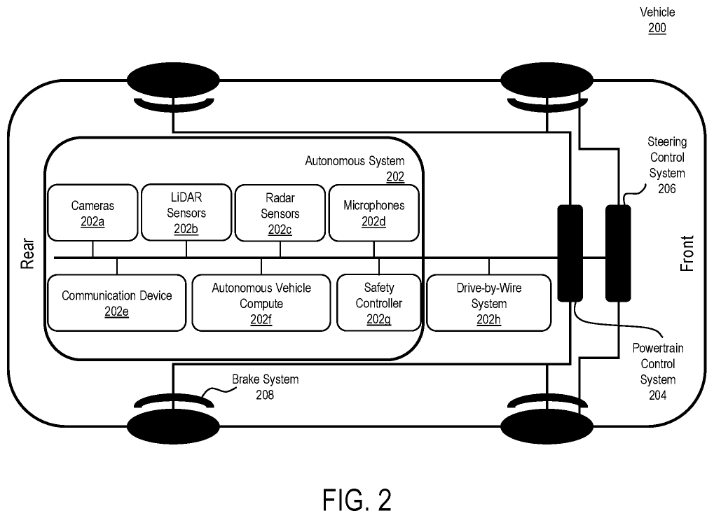

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, remote AV system 114, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 includes autonomous system 202, powertrain control system 204, steering control system 206, and brake system 208. In some embodiments, vehicle 200 is the same as or similar to vehicle 102 (see FIG. 1). In some embodiments, vehicle 102 have autonomous capability (e.g., implement at least one function, feature, device, and/or the like that enable vehicle 200 to be partially or fully operated without human intervention including, without limitation, fully autonomous vehicles (e.g., vehicles that forego reliance on human intervention), highly autonomous vehicles (e.g., vehicles that forego reliance on human intervention in certain situations), and/or the like). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, and drive-by-wire (DBW) system 202h.

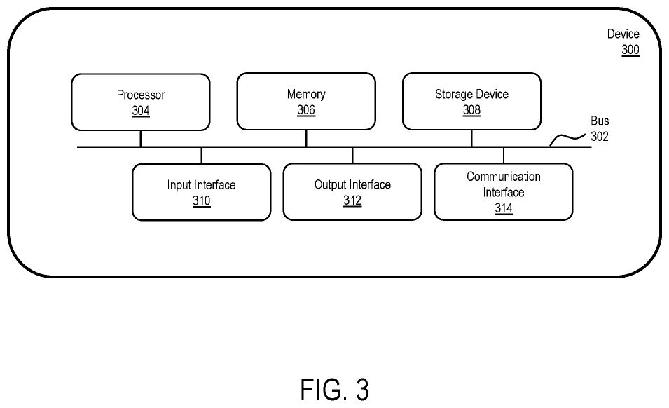

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a charge-coupled device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Laser Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c. In some embodiments, the radar sensor 202c can be configured to detect signals emitted by radio frequency devices and/or near field communication devices, such as radio frequency data including authentication data associated with a user.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e include at least one device configured to be in communication with cameras 202a, LiDAR sensors 202b, radar sensors 202c, microphones 202d, autonomous vehicle compute 202f, safety controller 202g, and/or DBW system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like) a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to start moving forward, stop moving forward, start moving backward, stop moving backward, accelerate in a direction, decelerate in a direction, perform a left turn, perform a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102), at least one device of other devices/objects shown in FIG. 1, and/or one or more devices of network 112 (e.g., one or more devices of a system of network 112). In some embodiments, one or more devices of vehicles 102 (e.g., one or more devices of a system of vehicles 102), at least one device of other devices/objects shown in FIG. 1, and/or one or more devices of network 112 (e.g., one or more devices of a system of network 112) include at least one device 300 and/or at least one component of device 300.

Bus 302 includes a component that permits communication among the components of device 300. In some embodiments, processor 304 is implemented in hardware, software, or a combination of hardware and software. In some examples, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a WiFi® interface, a cellular network interface, and/or the like.

In some embodiments, device 300 performs one or more processes described herein. Device 300 performs these processes based on processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

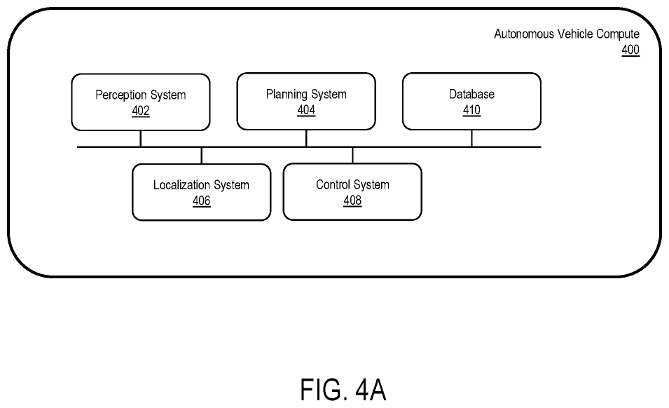

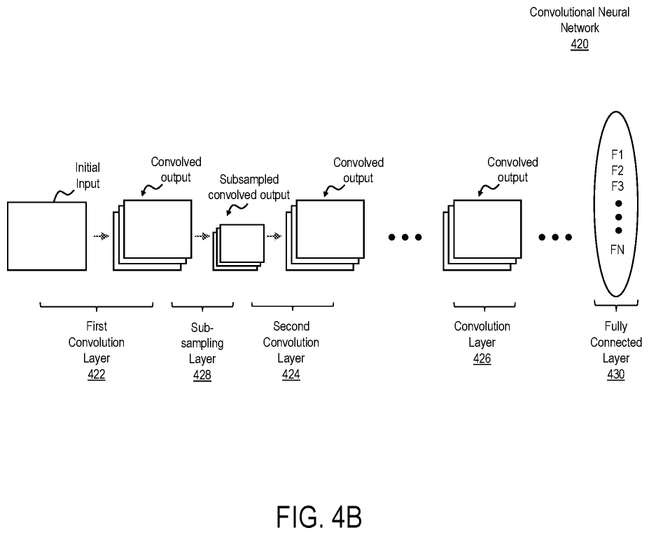

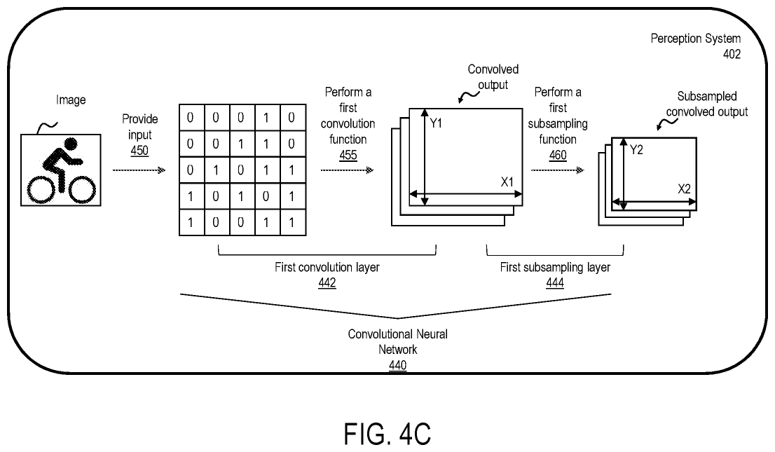

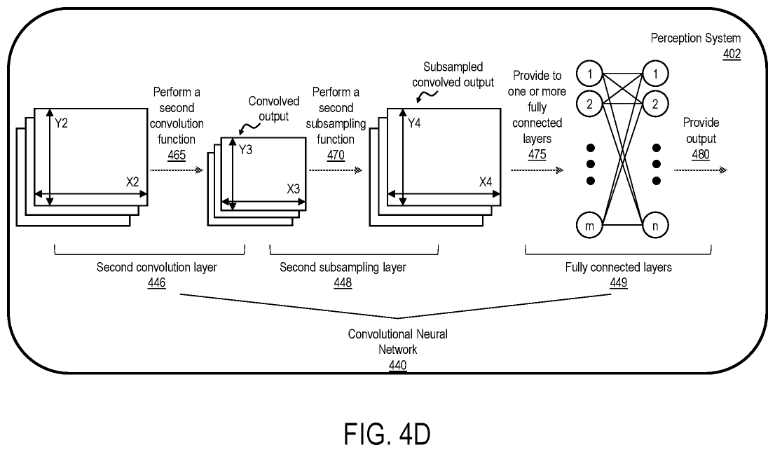

Referring now to FIG. 4A, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits [ASICs], Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like). An example of an implementation of a machine learning model is included below with respect to FIGS. 4B-4D.

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

Referring now to FIG. 4B, illustrated is a diagram of an implementation of a machine learning model. More specifically, illustrated is a diagram of an implementation of a convolutional neural network (CNN) 420. For purposes of illustration, the following description of CNN 420 will be with respect to an implementation of CNN 420 by perception system 402. However, it will be understood that in some examples CNN 420 (e.g., one or more components of CNN 420) is implemented by other systems different from, or in addition to, perception system 402 such as planning system 404, localization system 406, and/or control system 408. While CNN 420 includes certain features as described herein, these features are provided for the purpose of illustration and are not intended to limit the present disclosure.

CNN 420 includes a plurality of convolution layers including first convolution layer 422, second convolution layer 424, and convolution layer 426. In some embodiments, CNN 420 includes sub-sampling layer 428 (sometimes referred to as a pooling layer). In some embodiments, sub-sampling layer 428 and/or other subsampling layers have a dimension (i.e., an amount of nodes) that is less than a dimension of an upstream system. By virtue of sub-sampling layer 428 having a dimension that is less than a dimension of an upstream layer, CNN 420 consolidates the amount of data associated with the initial input and/or the output of an upstream layer to thereby decrease the amount of computations necessary for CNN 420 to perform downstream convolution operations. Additionally, or alternatively, by virtue of sub-sampling layer 428 being associated with (e.g., configured to perform) at least one subsampling function (as described below with respect to FIGS. 4C and 4D), CNN 420 consolidates the amount of data associated with the initial input.

Perception system 402 performs convolution operations based on perception system 402 providing respective inputs and/or outputs associated with each of first convolution layer 422, second convolution layer 424, and convolution layer 426 to generate respective outputs. In some examples, perception system 402 implements CNN 420 based on perception system 402 providing data as input to first convolution layer 422, second convolution layer 424, and convolution layer 426. In such an example, perception system 402 provides the data as input to first convolution layer 422, second convolution layer 424, and convolution layer 426 based on perception system 402 receiving data from one or more different systems (e.g., one or more systems of a vehicle that is the same as or similar to vehicle 102), a remote AV system that is the same as or similar to remote AV system 114, a fleet management system that is the same as or similar to fleet management system 116, a V2I system that is the same as or similar to V2I system 118, and/or the like). A detailed description of convolution operations is included below with respect to FIG. 4C.

In some embodiments, perception system 402 provides data associated with an input (referred to as an initial input) to first convolution layer 422 and perception system 402 generates data associated with an output using first convolution layer 422. In some embodiments, perception system 402 provides an output generated by a convolution layer as input to a different convolution layer. For example, perception system 402 provides the output of first convolution layer 422 as input to sub-sampling layer 428, second convolution layer 424, and/or convolution layer 426. In such an example, first convolution layer 422 is referred to as an upstream layer and sub-sampling layer 428, second convolution layer 424, and/or convolution layer 426 are referred to as downstream layers. Similarly, in some embodiments perception system 402 provides the output of sub-sampling layer 428 to second convolution layer 424 and/or convolution layer 426 and, in this example, sub-sampling layer 428 would be referred to as an upstream layer and second convolution layer 424 and/or convolution layer 426 would be referred to as downstream layers.

In some embodiments, perception system 402 processes the data associated with the input provided to CNN 420 before perception system 402 provides the input to CNN 420. For example, perception system 402 processes the data associated with the input provided to CNN 420 based on perception system 420 normalizing sensor data (e.g., image data, LiDAR data, radar data, and/or the like).

In some embodiments, CNN 420 generates an output based on perception system 420 performing convolution operations associated with each convolution layer. In some examples, CNN 420 generates an output based on perception system 420 performing convolution operations associated with each convolution layer and an initial input. In some embodiments, perception system 402 generates the output and provides the output as fully connected layer 430. In some examples, perception system 402 provides the output of convolution layer 426 as fully connected layer 430, where fully connected layer 420 includes data associated with a plurality of feature values referred to as F1, F2 . . . FN. In this example, the output of convolution layer 426 includes data associated with a plurality of output feature values that represent a prediction.

In some embodiments, perception system 402 identifies a prediction from among a plurality of predictions based on perception system 402 identifying a feature value that is associated with the highest likelihood of being the correct prediction from among the plurality of predictions. For example, where fully connected layer 430 includes feature values F1, F2, . . . FN, and F1 is the greatest feature value, perception system 402 identifies the prediction associated with F1 as being the correct prediction from among the plurality of predictions. In some embodiments, perception system 402 trains CNN 420 to generate the prediction. In some examples, perception system 402 trains CNN 420 to generate the prediction based on perception system 402 providing training data associated with the prediction to CNN 420.

Referring now to FIGS. 4C and 4D, illustrated is a diagram of example operation of CNN 440 by perception system 402. In some embodiments, CNN 440 (e.g., one or more components of CNN 440) is the same as, or similar to, CNN 420 (e.g., one or more components of CNN 420) (see FIG. 4B).

At step 450, perception system 402 provides data associated with an image as input to CNN 440 (step 450). For example, as illustrated, perception system 402 provides the data associated with the image to CNN 440, where the image is a greyscale image represented as values stored in a two-dimensional (2D) array. In some embodiments, the data associated with the image may include data associated with a color image, the color image represented as values stored in a three-dimensional (3D) array. Additionally, or alternatively, the data associated with the image may include data associated with an infrared image, a radar image, and/or the like. In some embodiments, the infrared image and/or the radar image can be captured by a camera for authentication of a user of the vehicle.

At step 455, CNN 440 performs a first convolution function. For example, CNN 440 performs the first convolution function based on CNN 440 providing the values representing the image as input to one or more neurons (not explicitly illustrated) included in first convolution layer 442. In this example, the values representing the image can correspond to values representing a region of the image (sometimes referred to as a receptive field). In some embodiments, each neuron is associated with a filter (not explicitly illustrated). A filter (sometimes referred to as a kernel) is representable as an array of values that corresponds in size to the values provided as input to the neuron. In one example, a filter may be configured to identify edges (e.g., horizontal lines, vertical lines, straight lines, and/or the like). In successive convolution layers, the filters associated with neurons may be configured to identify successively more complex patterns (e.g., arcs, objects, and/or the like).

In some embodiments, CNN 440 performs the first convolution function based on CNN 440 multiplying the values provided as input to each of the one or more neurons included in first convolution layer 442 with the values of the filter that corresponds to each of the one or more neurons. For example, CNN 440 can multiply the values provided as input to each of the one or more neurons included in first convolution layer 442 with the values of the filter that corresponds to each of the one or more neurons to generate a single value or an array of values as an output. In some embodiments, the collective output of the neurons of first convolution layer 442 is referred to as a convolved output. In some embodiments, where each neuron has the same filter, the convolved output is referred to as a feature map.

In some embodiments, CNN 440 provides the outputs of each neuron of first convolutional layer 442 to neurons of a downstream layer. For purposes of clarity, an upstream layer can be a layer that transmits data to a different layer (referred to as a downstream layer). For example, CNN 440 can provide the outputs of each neuron of first convolutional layer 442 to corresponding neurons of a subsampling layer. In an example, CNN 440 provides the outputs of each neuron of first convolutional layer 442 to corresponding neurons of first subsampling layer 444. In some embodiments, CNN 440 adds a bias value to the aggregates of all the values provided to each neuron of the downstream layer. For example, CNN 440 adds a bias value to the aggregates of all the values provided to each neuron of first subsampling layer 444. In such an example, CNN 440 determines a final value to provide to each neuron of first subsampling layer 444 based on the aggregates of all the values provided to each neuron and an activation function associated with each neuron of first subsampling layer 444.

At step 460, CNN 440 performs a first subsampling function. For example, CNN 440 can perform a first subsampling function based on CNN 440 providing the values output by first convolution layer 442 to corresponding neurons of first subsampling layer 444. In some embodiments, CNN 440 performs the first subsampling function based on an aggregation function. In an example, CNN 440 performs the first subsampling function based on CNN 440 determining the maximum input among the values provided to a given neuron (referred to as a max pooling function). In another example, CNN 440 performs the first subsampling function based on CNN 440 determining the average input among the values provided to a given neuron (referred to as an average pooling function). In some embodiments, CNN 440 generates an output based on CNN 440 providing the values to each neuron of first subsampling layer 444, the output sometimes referred to as a subsampled convolved output.

At step 465, CNN 440 performs a second convolution function. In some embodiments, CNN 440 performs the second convolution function in a manner similar to how CNN 440 performed the first convolution function, described above. In some embodiments, CNN 440 performs the second convolution function based on CNN 440 providing the values output by first subsampling layer 444 as input to one or more neurons (not explicitly illustrated) included in second convolution layer 446. In some embodiments, each neuron of second convolution layer 446 is associated with a filter, as described above. The filter(s) associated with second convolution layer 446 may be configured to identify more complex patterns than the filter associated with first convolution layer 442, as described above.

In some embodiments, CNN 440 performs the second convolution function based on CNN 440 multiplying the values provided as input to each of the one or more neurons included in second convolution layer 446 with the values of the filter that corresponds to each of the one or more neurons. For example, CNN 440 can multiply the values provided as input to each of the one or more neurons included in second convolution layer 446 with the values of the filter that corresponds to each of the one or more neurons to generate a single value or an array of values as an output.

In some embodiments, CNN 440 provides the outputs of each neuron of second convolutional layer 446 to neurons of a downstream layer. For example, CNN 440 can provide the outputs of each neuron of first convolutional layer 442 to corresponding neurons of a subsampling layer. In an example, CNN 440 provides the outputs of each neuron of first convolutional layer 442 to corresponding neurons of second subsampling layer 448. In some embodiments, CNN 440 adds a bias value to the aggregates of all the values provided to each neuron of the downstream layer. For example, CNN 440 adds a bias value to the aggregates of all the values provided to each neuron of second subsampling layer 448. In such an example, CNN 440 determines a final value to provide to each neuron of second subsampling layer 448 based on the aggregates of all the values provided to each neuron and an activation function associated with each neuron of second subsampling layer 448.

At step 470, CNN 440 performs a second subsampling function. For example, CNN 440 can perform a second subsampling function based on CNN 440 providing the values output by second convolution layer 446 to corresponding neurons of second subsampling layer 448. In some embodiments, CNN 440 performs the second subsampling function based on CNN 440 using an aggregation function. In an example, CNN 440 performs the first subsampling function based on CNN 440 determining the maximum input or an average input among the values provided to a given neuron, as described above. In some embodiments, CNN 440 generates an output based on CNN 440 providing the values to each neuron of second subsampling layer 448.

At step 475, CNN 440 provides the output of each neuron of second subsampling layer 448 to fully connected layers 449. For example, CNN 440 provides the output of each neuron of second subsampling layer 448 to fully connected layers 449 to cause fully connected layers 449 to generate an output. In some embodiments, fully connected layers 449 are configured to generate an output associated with a prediction (sometimes referred to as a classification). The prediction may include an indication that an object included in the image provided as input to CNN 440 includes an object, a set of objects, and/or the like. In some embodiments, perception system 402 performs one or more operations and/or provides the data associated with the prediction to a different system, described herein.

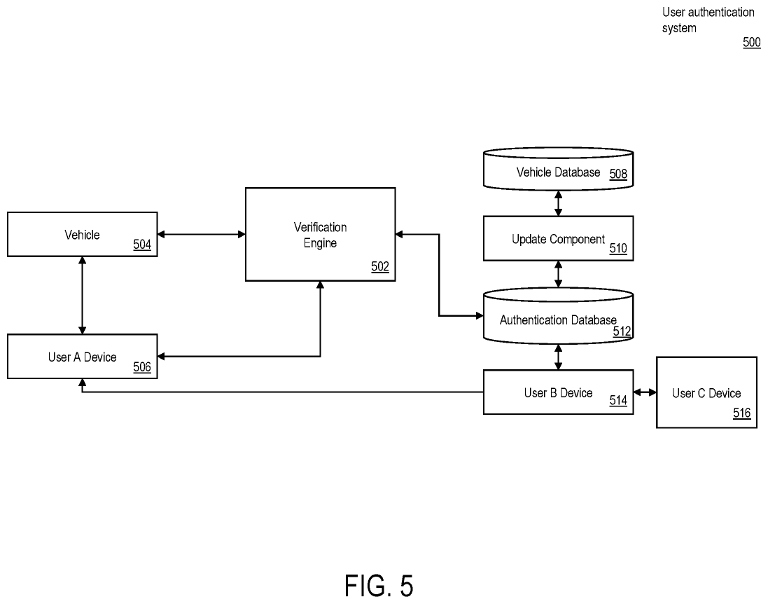

Referring now to FIG. 5, FIG. 5 is a diagram of an implementation of an example user authentication system 500 by which techniques of the present disclosure can be implemented. As shown in FIG. 5, user authentication system 500 includes a verification engine 502, a vehicle 504, a user device 506 (referred to herein as user A device 506), a vehicle database 508, an update component 510, an authentication database 512, a user device 514 (referred to herein as user B device 514), and a user device 516 (referred to herein as user C device 516).

The verification engine 502 can include one or more devices communicatively coupled with vehicle 504, user A device 506, and authentication database 512. For example, verification engine 502 can include a device (or one or more components of a device) that is the same as, or similar to, device 300 of FIG. 3. In some embodiments, one or more of the functions described herein as associated with the verification engine 502 can be implemented by, or in coordination with, one or more other devices such as: vehicle 504 (and/or a vehicle that is the same as, or similar to, vehicle 200 of FIG. 2), a remote AV system (e.g., a remote AV system that is the same as, or similar to, remote AV system 114 of FIG. 1), a fleet management system (e.g., a fleet management system that is the same as, or similar to, fleet management system 116 of FIG. 1), and/or the like. In some embodiments, the verification engine 502 can be associated with (e.g., operated by) a ridesharing company, a merchant, and/or the like. In some embodiments, the verification engine 502 can be incorporated into the vehicle 504 (e.g., by one or more systems of the vehicle 504) and/or can be an external component (e.g., a processor, a server, a computing system, etc.) communicatively coupled to the vehicle 504.

The vehicle 504 can include one or more devices communicatively coupled with the verification engine 502 and/or the user A device 506. For example, the vehicle 504 can include a vehicle that is the same as, or similar to, vehicles 102 of FIG. 1 or vehicle 200 of FIG. 2. In some embodiments, the vehicle 504 can be associated with (e.g., operated by) an autonomous vehicle company, a ridesharing company, a merchant, and/or the like. In some embodiments, the vehicle 504 can include authentication components including cameras (e.g., cameras 202a), LiDAR sensors (e.g., sensors 202b), radar sensors (e.g., sensors 202c), microphones (e.g., microphones 202c), one or more communication devices (e.g., communication device(s) 202e), and one or more operational components that can be available after user authentication. For example, a vehicle's camera can perform scanning for first authentication data. Alternatively or in addition to, the vehicle 504 can include a scanner and/or a reader designed to scan/read the authentication data. Moreover, in some alternate embodiments, the vehicle 504 can include an authentication interface (e.g., keypad) that allows a user to enter authentication data (e.g., a sequence of numbers defining a code that may be included in the authentication data). The operational components of the vehicle 504 that can be available after a successful user authentication can include access components (e.g. doors, trunk, etc.), locking components of the access components, driving components (e.g., autonomous vehicle compute 202f and/or 400 (including perception system 402, planning system 404, localization system 406, control system 408, and database 410), as shown in FIGS. 2 and 4A), a safety controller (e.g., safety controller 202g), and/or a drive-by-wire system (e.g., drive-by-wire system 202h).

The user device 506 (referred to herein as user A device 506), the user device 514 (referred to herein as user B device 514), and the user device 516 (referred to herein as user C device 516) can include one or more devices communicatively coupled with the vehicle 504, the verification engine 502 and/or the authentication database 512. For example, the user device 506 can be communicatively coupled with the vehicle 504, the verification engine 502 and/or the user device 514. The user device 514 can be communicatively coupled with the user device 506, the authentication database 512, and the user device 516. The user device 506, the user device 514, and the user device 516 can include any type of processor and memory based device, such as, for example, cellular phones, smart phones, tablet computers, laptop computers, desktop computers, workstations, personal digital assistants (PDA), network appliances, cameras, enhanced general packet radio service (EGPRS) mobile phones, media players, navigation devices, email devices, game consoles, or an appropriate combination of any two or more of these devices or other data processing devices. The user device 506, the user device 514, and the user device 516 can include different computing system configurations, such as different operating systems, different processing capabilities, different hardware components, and/or other differences to sequentially or concurrently execute authentication services. The user device 506, the user device 514, and the user device 516 can include any combination of fixed and variable computing components. The user device 506, the user device 514, and the user device 516 can include an interface (input interface(s) 310, and/or communication interface(s) 314 described with reference to FIG. 3), cameras (such as the cameras 202a described with reference to FIG. 2), sensors (such as the sensors 202b, 202c described with reference to FIG. 2), microphones (such as the microphones 202d described with reference to FIG. 2), and/or one or more communication components (such as communication device(s) 202e described with reference to FIG. 2).

The vehicle database 508 can be accessed by the update component 510. For example, the vehicle database 508 (e.g., database 410 described with reference to FIG. 4) can be configured to store data sent by the update component 510 including vehicle records (e.g., incident records 122A and score records 122B described with reference to FIG. 2). In some embodiments, the vehicle database 508 can include a storage component (e.g., a storage component that is the same as or similar to storage component 308 described with reference to FIG. 3) that stores data and/or software related to the operation and uses of the example user authentication system 500.

The authentication database 512 can be communicatively coupled with the verification engine 502, the update component 510 and/or the user device 514. For example, the authentication database 512 can include a database that is the same as, or similar to, database 410 described with reference to FIG. 4. In some embodiments, the authentication database 512 stores authentication data associated with user authentication processes for the vehicle 504. The authentication data can include user identifiers (e.g., strings, characters, QR codes), passwords (e.g., numerical and/or alphanumerical passwords), biometric user authenticators, and/or vehicle identification data (e.g., unique ID corresponding to the vehicle and/or the like). In some examples, the authentication database 512 stores a mapping between users and vehicles 504 defining an access level of an authenticated user to a particular vehicle 504. In some examples, the authentication database 512 stores a mapping between users and vehicles 504 relative to regions (e.g., driving regions selected by user authenticated as vehicle owner or service, update, and/or repair locations), where the vehicle 504 can be accessed by authenticated users different from a vehicle owner. The authentication database 512 can include a multitenant database architecture (e.g., multitenant database containers (MDC)), such that each vehicle 504 of the user authentication system 500 (including multiple vehicles 504) can have respective authentication data stored by the authentication database 512 and can be served by separate instances of the user authentication system 500 when using authentication services (applications). The authentication database 512 can include a runtime database that holds most recent authentication data and respective vehicle identifiers to enable authentication processes for the vehicle 504. The vehicle database 508 and the authentication database 512 can include a cloud database system environment, although other types of databases can be used as well. In some embodiments, the vehicle database 508 and the authentication database 512 can include an on-premise database system (e.g., system databases, vehicle integrated databases, etc.).

The update component 510 can include one or more devices communicatively coupled with the vehicle database 508 and the authentication database 512. For example, the update component 510 can include a device (or one or more components of a device) that is the same as, or similar to, one or more components of the device 300 of FIG. 3. In some embodiments, one or more of the functions described herein as associated with the update component 510 can be implemented by, or in coordination with, one or more other devices such as: vehicle 504 (and/or a vehicle that is the same as, or similar to, vehicle 200 of FIG. 2), a remote AV system (e.g., a remote AV system that is the same as, or similar to, remote AV system 114 of FIG. 1), a fleet management system (e.g., a fleet management system that is the same as, or similar to, fleet management system 116 of FIG. 1), and/or the like. In some embodiments, the update component 510 can be associated with an authentication process associated with a user (e.g., operating user of a ridesharing company, a service provider, a vehicle owner, a merchant, and/or the like) of the vehicle 504. For example, the update component 510 can generate and send to the vehicle database 508 and the authentication database 512 authentication data updates (data addition and/or removal) associated with authentication processes of the vehicle 504.

With continued reference to FIG. 5, one or more functions will be described as being performed by the verification engine 502. The number and arrangement of the components and/or devices of the example user authentication system 500, shown in FIG. 5 are provided as an example. There may be additional systems and/or devices, fewer systems and/or devices, different systems and/or device, or differently arrangement systems and/or devices than those shown in FIG. 5. Furthermore, two or more systems and/or devices show in FIG. 5 may be implemented within a single system or a single device, or a single system or a single device shown in FIG. 5 may be implemented as multiple, distributed systems or devices. Additionally, or alternatively, a set of systems or a set of devices (e.g., one or more systems, one or more devices) of the example user authentication system 500 may perform one or more functions described as being performed by another set of systems or another set of devices of the example user authentication system 500.

The example user authentication system 500 can be configured to limit and control access to the vehicle 504 to authorized users accessing a user device 506, 514, 516. For example, the example user authentication system 500 can be configured to control unlocking/locking of one or more compartments (e.g., trunk, doors, etc.) and/or to control execution of an operation (e.g., motion maneuver) of the vehicle 504, etc.

In some embodiments, the verification engine 502 receives first authentication data. For example, the verification engine 502 can receive first authentication data based on generation of sensor data by vehicle 504 or based on an authentication request received from the user device 506. Referring to the example of the sensor data generated by vehicle 504, vehicle 504 generates camera data associated with one or more images, the one or more images can include a representation of information corresponding to an authentication request (e.g., an order number, a QR code generated for an order, contents of an order, and/or the like). The sensor data can include authentication data associated with a particular user (e.g., a QR code, a pin code, etc.) and objects included in the environment adjacent to the vehicle 504 that can be associated with a set authentication. In the described example, the vehicle 504 includes the camera data in the first authentication data and vehicle 504 transmits the first authentication data to verification engine 502. In some embodiments, the vehicle 504 also includes vehicle identification data associated with an identifier for vehicle 504. For example, vehicle 504 can include vehicle identification data associated with a unique ID corresponding to the vehicle and/or the like.

The authentication request received by the verification engine 502 from the user device 506 can be generated by an application (e.g., a mobile application, provided by a service vendor, to unlock the vehicle, such as “swipe to unlock” applications) of the user device 506 associated with an authenticated operation of the vehicle 504. In some embodiments, the user device 506 can transmit, to the vehicle 504 or the verification engine 502, authentication data received from and generated by the user B device 514 (e.g., order number, details of order, etc.) based on data/information supplied by the user C device 516 (e.g., an operation order associated with the vehicle 504). For example, the user of the user device 506 can be a delivery merchant and the authentication data can include a QR code that can include an order number corresponding to an order associated with the vehicle 504, placed by a customer of the merchant accessing the user C device 516. The QR code can also include a vehicle identification information corresponding to the vehicle 504 selected and/or assigned by the merchant for delivery of the customer order. The authentication data/information can be transmitted to the authentication database 512 that authentication data/information for the vehicle 504 to determine whether the transmitted data/information matches data/information stored in the authentication database 512 and is associated with a user (e.g., merchant) authorized to access the vehicle 504. If there is a match, the vehicle 504 can receive a signal that can activate a component (e.g., unlock a trunk, unlock doors, start the vehicle, etc.). Otherwise, if no match is found, an error can be generated and the user can be prevent from accessing the vehicle 504. In some implementations, an interface of the vehicle 504 and/or of the user device 506 can display an alert prompting the user to repeat the authentication process (e.g., re-authenticate).

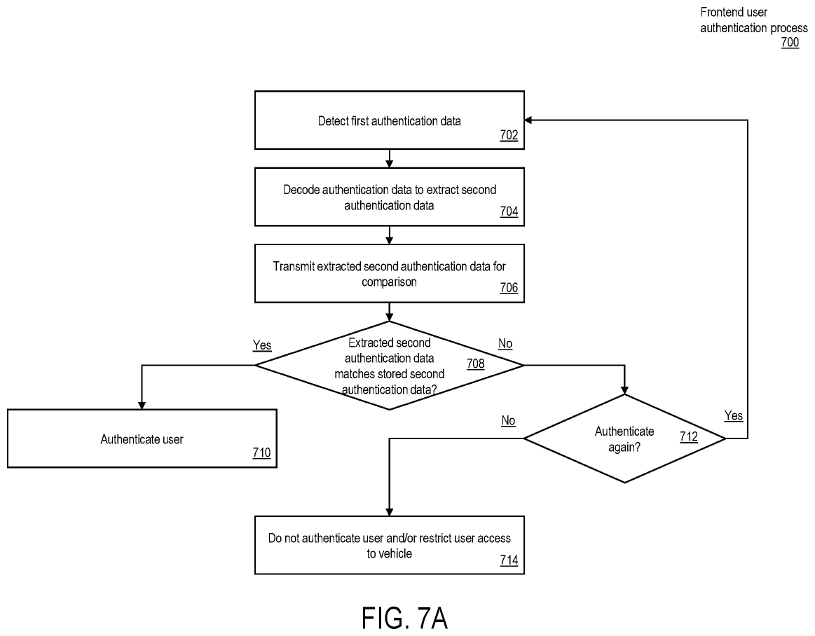

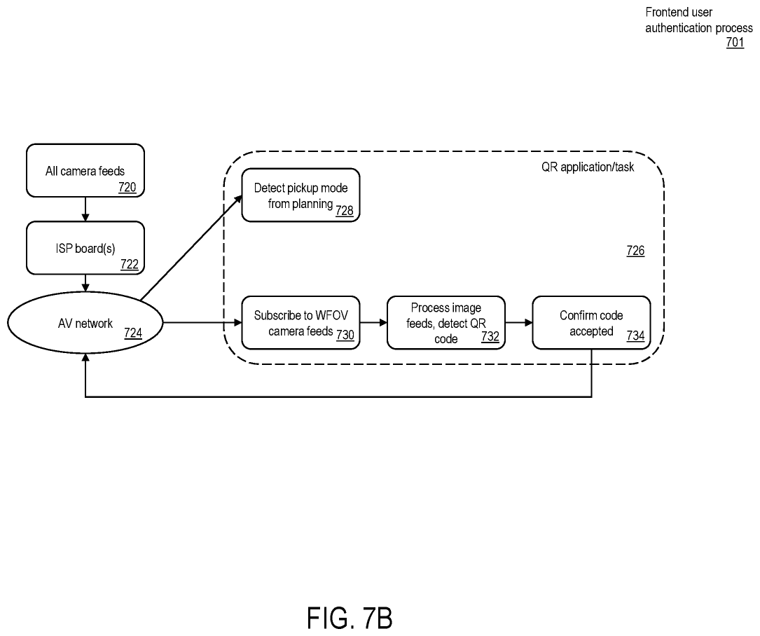

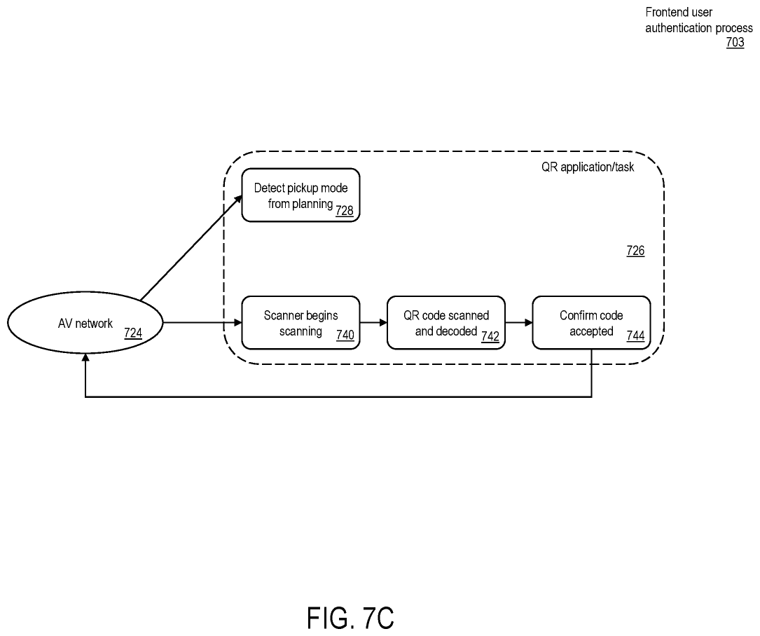

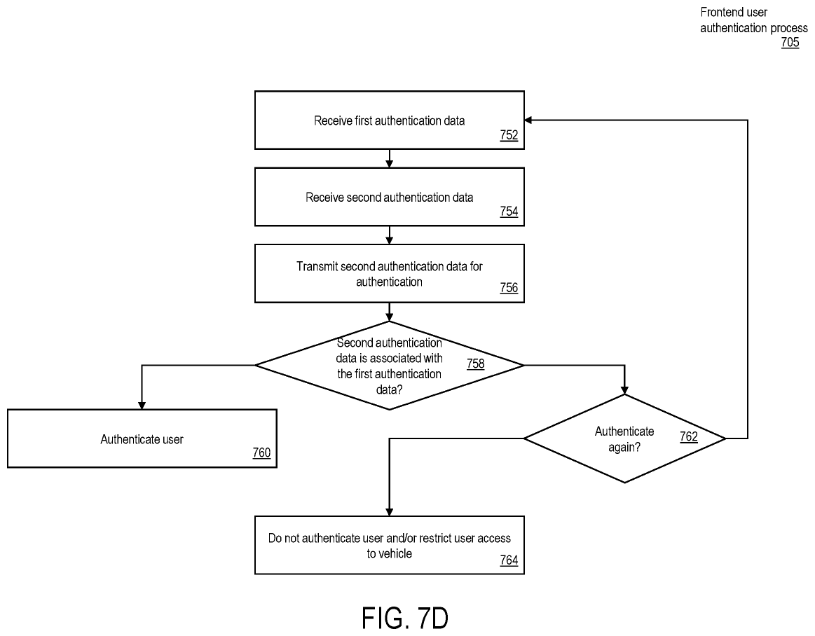

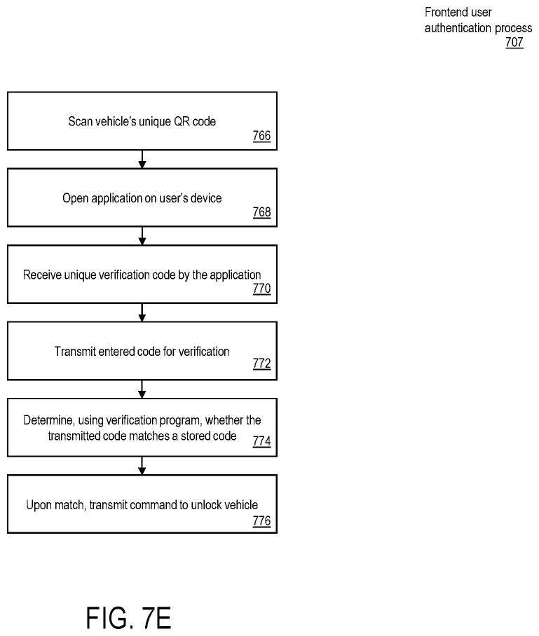

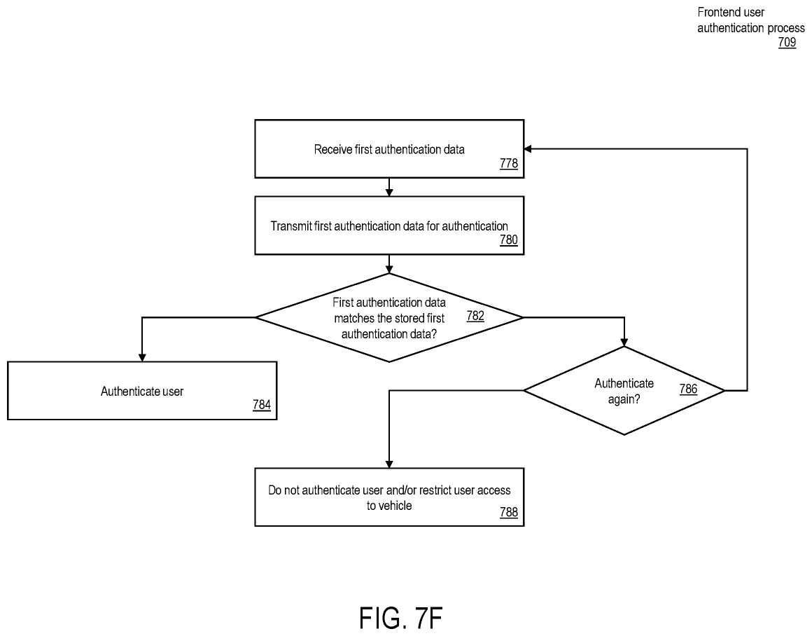

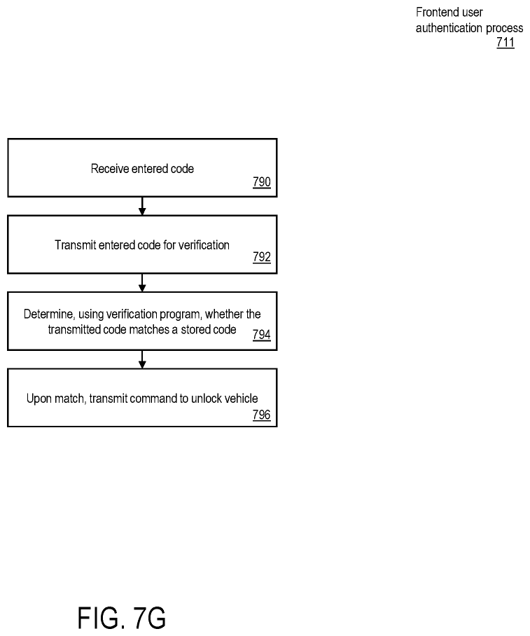

The following is a discussion of an example operation of the user authentication system 500. The vehicle's 504 controller, and/or any other processor, such as, for example, the verification engine 502 (which, as stated above, may or may not be incorporated into the vehicle's controller) detects a first authentication data (e.g., QR code, pin code, etc.) on a device 506 associated with a particular user (e.g., merchant delivery person). The first authentication data can include data/information generated by the user B device 514 (e.g., order number, details of order, etc.) based on data/information supplied by the user C device 516 (e.g., an order). User C device 516 can be associated with a customer of the user B. The first authentication data also includes information retrieved from the vehicle database 508 that stores vehicles' identifiers. For example, the user device 514, upon receiving data/information from the user device 516 and as part of generating first authentication data, assigns one of the vehicle identifiers retrieved from the vehicle database 508 to the first authentication data. The first authentication data can include the assigned vehicle identifier or second authentication data that is stored in the authentication database 512 (e.g., an order database), whereby the assigned vehicle identifier/second authentication data forms a portion of the first authentication data. The device 514 can transmit the first authentication data to user A device 506 to enable the user of the user A device 506 to initiate the process of authentication for the purposes of initiation of an operation of the vehicle 504. The first authentication data can be presented to the vehicle 504 in a variety of frontend processes, as discussed with reference to FIGS. 7A-7G.

Continuing with the example scenario, upon assignment of the vehicle identifier to a particular order, the vehicle 504 corresponding to the assigned vehicle identifier, drives to a geographical location (e.g., merchant's location) where presentation of the first authentication data to one or more of vehicle's sensors can be performed. At the target location, the vehicle's processors can switch to a “waiting for authentication” state, whereby one or more of vehicle's sensors (e.g., cameras 202a, LiDAR sensors 202b, radar sensors 202c, microphones 202d, described with reference to FIG. 2, scanners, signal receivers (audio, video, RF, NFC, Bluetooth™, etc.), keypads, etc.) can perform scanning to retrieve authentication data. The scanning can be periodic (e.g., every minute, every five minutes), continuous, and/or in any other desired fashion. Alternatively, or in addition to, the vehicle's sensors, upon arrival to the geographical location, may enter into a sleep state, whereby presentation of the first authentication data may wake up one or more such sensors for the purposes of reading, processing, etc. of the first authentication data.

Within continued reference to the example scenario, in response to receiving the first authentication data, the verification engine 502 can compare the presented first authentication data and the second authentication data (stored in the authentication database 512) to determine whether a portion (i.e., the assigned vehicle identifier) included in the first authentication data matches the second authentication data stored in the authentication database 512. For example, the verification engine 502 extracts the assigned vehicle identifier (e.g., from the QR code presented by user A to the vehicle) from the presented first authentication data and transmits the extracted data for comparison with the data stored in the authentication database 512. If the extracted portion of the first authentication data matches the stored second authentication data, the user A is authenticated. In response to receiving a confirmation of a successful authentication, from the verification engine 502, the vehicle 504 can be configured to execute at least one action associated with operation of the vehicle 504. The actions include at least one of the following: unlocking at least one compartment (e.g., a trunk, door(s), etc.) of the vehicle 504, locking at least one compartment of the vehicle 504, executing at least one motion maneuver by the vehicle 504, and any combination thereof. The motion maneuver includes determining at least one: a speed, a position, an acceleration, a direction of movement, a travel destination, and any combination thereof of the vehicle 504. Otherwise, if no match is determined, the user is not authenticated and prevented from accessing the vehicle 504. The user device 506, 514, 516 can generate a request for resubmission of the first authentication data again.

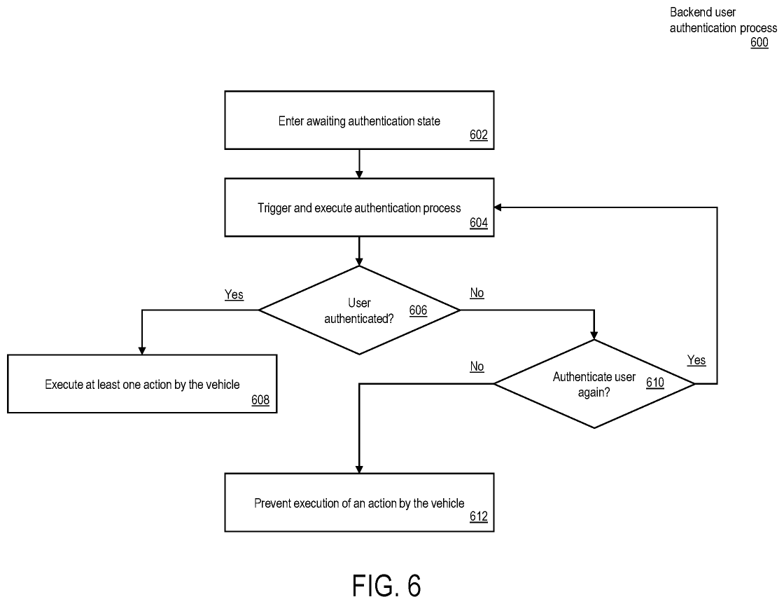

FIG. 6 is a flow chart illustrating an example of a backend process 600 for performing user authentication, according to some embodiments of the current subject matter. The process 600 can be performed by one or more components of the user authentication system 500 shown in FIG. 5.

The process 600 can be executed in the following exemplary, non-limiting scenario. A customer (“Customer A”) submits (e.g., using device 516) an order through a partner application (e.g., a meal delivery service). The order is fulfilled by a specific merchant (e.g., specifically, employee “User A”). The delivery partner's system (e.g., device 514) creates a unique Order ID (“Order A”) and logs it into the order database (e.g., database 512). The database contains all relevant information associated with this order (and all other orders). The order information is sent to the merchant (e.g., device 506, who prepares the order accordingly. At a specified point (e.g., based on expected completion time), the partner (e.g., using device 514) assigns a vehicle (e.g., vehicle 504) to complete the delivery. This assignment is based on a database (e.g., database 508) of available vehicles and/or their locations. The order database (e.g., database 512) is updated (e.g., using update component 510) with the vehicle assignment (e.g., using an identifier of the assigned vehicle) for the active order. In other words, Order A is officially assigned to vehicle 504 in the order database (e.g., database 512).

The vehicle 504 then drives to the merchant location and parks. The merchant (e.g., using device 506) is notified of the vehicle's arrival to deliver the specific order (e.g., via a message “Vehicle A has arrived for Order A's delivery to Customer A” that may be displayed on a user interface of device 506). The vehicle 504 enters the “Awaiting Authentication” state, at which point it is ready for authentication attempts.

The merchant employee (“User A”) approaches the vehicle 504 with the order in-hand. The user A attempts to authenticate by submitting the unique Order Code of the order (“Order A”) while at the vehicle 504.

The verification engine 502 pulls the expected Order Code from the order database (e.g., authentication database 512) that vehicle 504 is assigned to retrieve. It compares this to the user-submitted Order Code at vehicle 504. If the codes match, the authentication is verified. The verification engine 502 transmits this result to a vehicle controller and/or cloud-based controller, which sends an unlock command to the vehicle 504 to, for instance, unlock its doors and trunk, providing User A access. If the codes do not match, the authentication is denied. The verification engine 502 transmits this result to the vehicle controller and/or cloud-based controller and the vehicle 504 remains locked. The vehicle controller and/or cloud-based controller then notifies the user A of this result. The user A is prompted to retry with a new Order Code or is connected to a remote customer assistance (RCA) system to assist and control access to the vehicle 504.

Referring back to FIG. 6, at 602, an awaiting authentication statement may be initiated and/or entered into by the vehicle 504. For example, after assignment of the vehicle identifier from the vehicle database 508, the vehicle's 504 controller can be configured to execute one or more driving maneuvers to cause the vehicle to drive to a predetermined geographical location (e.g., merchant's location). Once at the location, the vehicle's 504 sensors (e.g., cameras, scanners, etc.) and/or other processing components may enter into the awaiting authentication state, as discussed above.

At 604, upon presentation (e.g., by the user A and/or device 506) of a first authentication data/information to one of vehicle's sensors and/or any other components, the verification engine 502 triggers and executes an authentication process. During the authentication process, the authentication data/information provided by the user A and/or device 506 can be compared with the information stored in the authentication database 512 to determine whether first authentication data/information contains data/information (which can be extracted) associated with the vehicle that matches data/information stored in the authentication database 512.

If, at 606, the data/information extracted from the first authentication data/information matches the stored data/information, the vehicle's controller executes one or more actions (e.g., unlocking one or more compartments of the vehicle), at 608. Otherwise, if the user is not authenticated, at 606, the vehicle's controller prevents access to the vehicle. Alternatively or in addition to, another attempt at authentication is made, i.e., the user can be requested to present first authentication data/information (e.g., QR code) to the vehicle's sensors again, at 610. If a decision to try to authenticate the user is made, the process 600 goes back to 604, where the authentication process is repeated. Otherwise, at 612, the vehicle's controller does not execute any further actions, e.g., actions associated with allowing the user A to access the vehicle.

FIG. 7A is a flow chart illustrating an example of a frontend process 700 for performing user authentication, according to some embodiments of the current subject matter. The process 700 can be performed by the user authentication system 500 shown in FIG. 5. The process 700 can be performed using existing vehicle's sensor equipment (e.g., cameras, scanners, etc.) and/or sensor equipment that can be added to the vehicle 504 and/or configured to communicate with the vehicle 504 controller and/or other processing equipment. In either situation, the vehicle's 504 sensor equipment can be configured to detect, scan, read, and/or allow for input in any other fashion data/information from the user A and/or user A's device 506.

The process 700 (as well as processes shown in FIGS. 7B-7G) can be initiated after the vehicle 504 has been assigned by the user B for performing a particular task (e.g., delivery of a customer C order to the customer) using that vehicle's identifier (as retrieved from the vehicle database 508) and has arrived and/or has been positioned at a geographical location where the process 700 can be performed.

At 702, one or more of the sensors of the vehicle 504 detects a first authentication data (e.g., QR code, key code, etc.). As discussed above, the first authentication data is presented by the user A and/or user A device 506. The first authentication data may be presented to the sensors of the vehicle 504 at a predetermined distance, e.g., a distance that is sufficient for the sensors to be able to perform detection, scanning, reading, and/or any other inputting (“detecting”) of the first authentication data. By way of a non-limiting example, the predetermined distance may be dependent on a particular sensor and may range from, for example, less than 3 centimeters (cm) to 40 cm.

The detected first authentication data is processed by the verification engine 502. Alternatively, or in addition to, the detected first authentication data is processed by the vehicle's controller and/or any other processor which can include the verification engine 502. Processing of the first authentication data includes extraction of a second authentication data, e.g., assigned vehicle identifier and/or any other data that has been included in the first authentication data, at 704.

The retrieved second authentication data (and/or first authentication data) is then transmitted (e.g., either by the vehicle's controller/processor and/or verification engine) for comparison with data stored in the authentication database 512, where the stored data is associated with the vehicle, at 706. Alternatively, or in addition to, the verification engine 502, upon receiving the first authentication data, extracts the second authentication data and queries and requests the authentication database 512 to transmit to it the stored data associated with the vehicle.

At 708, the extracted second authentication data and the stored data are compared. If there is match, the user A that presented the first authentication data to the vehicle is authenticated, at 710. As discussed above, this may result in one or more actions that can be performed by the vehicle, e.g., unlocking the trunk, unlocking one or more doors, starting the engine, turning on lights, driving to a particular location, etc. If there is no match, the vehicle can be prevented from performing actions that may be desired by the user A, e.g., access to the trunk, opening doors, etc. Alternatively, or in addition to, the user A can be prompted to re-authenticate, at 712. For example, the user A can be prompted to present the first authentication data to the vehicle again, at 702. Otherwise, if a decision is made not to re-authenticate the user A, at 712 (e.g., after a predetermined number of attempts), the user A is not authenticated, at 714, and the vehicle is prevented from performing any further actions that may involve, for example, user A's access to the vehicle.

FIG. 7B illustrates an exemplary frontend authentication process 701 that can be performed by the user authentication system 500 shown in FIG. 5, according to some embodiments of the current subject matter. The process 700 can be executed utilizing one or more camera feeds 720 of the vehicle's in-system programming (ISP) board components 722 and/or the autonomous vehicle (AV) network 724, which can be configured to execute one or more QR code scanning and/or reading tasks 726 (“QR task”). The tasks 726 can be executed by the verification engine 502 and/or any other processing component of the vehicle and/or a processing component outside of the vehicle. During processing, the QR scanning task(s) 726 waits for vehicle's planning component to enter a “pickup mode” 728 (e.g., awaiting detection of the QR code). Once in the pickup mode 728, the QR task 726 subscribes to the wide field of view (WFOV) camera feeds 730 and executes a search/processing of image feeds, detection, input, etc. 732 of a QR code (and/or any other image, code, etc.) using one or more image processing algorithms. Upon detecting a QR code (e.g., through presentation of the QR code to the camera by the user A), the QR task confirms 734 that a QR code is scanned and transmits the QR code data to planning 728 and/or other processing components for further processing, confirmation, etc.

For example, the process 701 can be used for authenticating users (e.g., merchant delivery personnel (user A)) that carry a paper receipt and/or image of a QR code (e.g., associated with a particular customer order), rather than using a mobile application into which the user needs to be signed in. This process can be advantageous to deliveries, where retailers loading a vehicle typically carry a paper receipt, but not a mobile device. Moreover, existing vehicle's hardware and/or software can be used for executing process 701.

FIG. 7C illustrates another exemplary frontend authentication process 703 that can be performed by the user authentication system 500 shown in FIG. 5, according to some embodiments of the current subject matter. For example, the process 703 can be implemented using one or more QR code scanners, cameras, sensors, etc. that can be positioned, for instance, on an inside trunk hatch glass, facing outwards, etc. and/or anywhere else on the vehicle. When the vehicle is parked and enters the awaiting authentication state, the scanners, cameras, sensors, etc. begin attempting to detect QR codes (or any other codes) positioned into its field of view. For example, the user holds up a QR code representing the Order ID to the scanner, the image is captured, processed, and decoded into the Order ID for verification. As shown in FIG. 7C, during the process 703, using the QR scanner output, the QR task 726 waits for the planning to enter a pickup mode 728. Once in the pickup mode 728, the QR task 726 tasks the vehicle's scanner to begin scanning, at 740, items in its field of view (FOV). When a QR code is detected, the code is decoded, at 742, and transmitted to the scanning application. The QR task 726 then confirms that the QR code is accepted, at 744, and transmits the QR code to the AV network 724.

Using the process 703, the user authentication system 500 can also authenticate users (e.g., user A) that carry a paper receipt and/or image of a QR code (e.g., associated with a particular customer order), rather than using a mobile application into which the user needs to be signed in. This process is likewise advantageous to deliveries. Further, the process 703 can be configured not to utilize the vehicle's sensor suite, and instead, use cameras/scanners, etc. that may be installed on the vehicle for the purposes of authentication.

FIG. 7D illustrates another exemplary frontend authentication process 705 that can be performed by the user authentication system 500 shown in FIG. 5, according to some embodiments of the current subject matter. For example, the process 705 can be implemented using one or more mobile applications for the purposes of authentication. For example, the process 705 can be executed in situations where each of delivery-enabled vehicles has a visible unique QR code that, when scanned, can link to an authentication mobile application. The user (e.g., user A) can scan the QR code on the vehicle using a mobile device, which may open a mobile application on the mobile device (alternatively, the user may be prompted to open the mobile application). At that point, the user may be prompted to input an alphanumeric verification code assigned to the order that they were asked to fulfill. The user-inputted code is transmitted to the verification engine 502 from the mobile application. The verification engine 502 compares the received data with the stored data and if a match is found, unlocks the vehicle. Otherwise, no further action is performed. The alphanumeric verification code can include a numeric only pin that is temporarily associated with the authentication performed by the authentication mobile application during a particular (set) period of time.

As shown in FIG. 7D, at 752, the verification engine 502 receives a first authentication data (e.g., QR code, key code, etc). The first authentication data is scanned by the user A device 506. The first authentication data may be visible on the vehicle 504 and can identify the vehicle 504.

At 754, the user A is prompted (e.g., using a mobile application opened on the device 506) to enter a second authentication data (e.g., order number). The entered second authentication data (and/or first authentication data) is then transmitted (e.g., either by the vehicle's controller/processor and/or verification engine) for comparison with data stored in the authentication database 512, where the stored data is associated with the vehicle, at 756. Alternatively, or in addition to, the verification engine 502, upon receiving the first authentication data and the second authentication data, queries and requests the authentication database 512 to transmit to it the stored data associated with the vehicle and the order.

At 758, the second authentication data and the stored data are compared. If there is match, the user A that scanned the first authentication data is authenticated, at 760. As discussed above, this may result in one or more actions that can be performed by the vehicle, e.g., unlocking the trunk, unlocking one or more doors, starting the engine, turning on lights, driving to a particular location, etc. If there is no match, the vehicle can be prevented from performing actions that may be desired by the user A, e.g., access to the trunk, opening doors, etc. Alternatively, or in addition to, the user A can be prompted to re-authenticate, at 762. For example, the user A can be prompted to scan the first authentication data again, at 752. Otherwise, if a decision is made not to re-authenticate the user A, at 762 (e.g., after a predetermined number of attempts), the user A is not authenticated, at 764, and the vehicle is prevented from performing any further actions that may involve, for example, user A's access to the vehicle.

FIG. 7E illustrates another exemplary frontend authentication process 707 that can be performed by the user authentication system 500 shown in FIG. 5, according to some embodiments of the current subject matter. The process 707 is similar to process 705 shown in FIG. 7D. The process 707 can be advantageous in situations where a user (e.g., user A) inputs and submits a specific code (e.g., an order number) using a mobile application (after scanning a vehicle's QR code), prompting transmission of the code to a cloud-based verification engine (e.g., verification engine 502) to check whether the inputted code matches vehicle's assigned order for pickup. While any user can scan a QR code of the vehicle and be prompted to open a mobile application (or cause the mobile application to automatically open) on their mobile device, only those who know a particular active verification code (e.g., order number) will be able to unlock the vehicle.

As shown in FIG. 7E, at 766, the vehicle's unique QR code is scanned (e.g., using user A mobile device 506), which prompts, either manual and/or automatic, opening of a mobile application on the user A device 506, at 768. The user is prompted to enter a unique verification code (e.g., an order number), which the mobile application receives, at 770. Upon receipt of the unique verification code, the code (and/or the scanned QR code) may be transmitted to the verification engine 502 for verification, at 772. The verification engine 502 compares the received data with data that is stored (e.g., in the authentication database 512), at 774, to determine whether there is a match. If match is determined, the verification engine 502 (e.g., through vehicle's various controllers and/or processing components) can unlock the vehicle and/or perform any other action, at 776. Otherwise, the vehicle can remain locked.

Using the process 707, the current subject matter can authenticate users who carry a paper receipt and personal mobile device, rather than a mobile application-connected device signed in for a specific user. This process can be especially applicable to deliveries, where retailers loading the vehicle carry a paper receipt and often a personal mobile device as well. No additional hardware may need to be installed on the vehicle.

FIG. 7F illustrates another exemplary frontend authentication process 709 that can be performed by the user authentication system 500 shown in FIG. 5, according to some embodiments of the current subject matter. For example, the process 709 can be implemented using one or more keypads and/or other code entry devices that may be positioned on the vehicle for the purposes of authentication. In this case, a user (e.g., user A) can input a key code that may be unique to a particular order, into the keypad, which is transmitted to the verification engine 502 for authentication. The verification engine 502 compares the received keypad entry with the stored data and if a match is found, unlocks the vehicle. Otherwise, no further action is performed.

As shown in FIG. 7F, at 778, the verification engine 502 receives a first authentication data (e.g., key code entered via a keypad, etc.). At 780, the entered first authentication data is then transmitted (e.g., either by the vehicle's controller/processor and/or verification engine) for comparison with data stored in the authentication database 512, where the stored data is associated with the vehicle. Alternatively, or in addition to, the verification engine 502, upon receiving the first authentication data, queries and requests the authentication database 512 to transmit to it the stored data associated with the vehicle and the order.

At 782, the first authentication data and the stored data are compared. If there is match, the user A that entered the first authentication data is authenticated, at 784. As discussed above, this may result in one or more actions that can be performed by the vehicle, e.g., unlocking the trunk, unlocking one or more doors, starting the engine, turning on lights, driving to a particular location, etc. If there is no match, the vehicle can be prevented from performing actions that may be desired by the user A, e.g., access to the trunk, opening doors, etc. Alternatively, or in addition to, the user A can be prompted to re-authenticate, at 786. For example, the user A can be prompted to re-enter the first authentication data on the keypad again, at 778. Otherwise, if a decision is made not to re-authenticate the user A, at 786 (e.g., after a predetermined number of attempts), the user A is not authenticated, at 788, and the vehicle is prevented from performing any further actions that may involve, for example, user A's access to the vehicle.

FIG. 7G illustrates another exemplary frontend authentication process 711 that can be performed by the user authentication system 500 shown in FIG. 5, according to some embodiments of the current subject matter. The process 711 is similar to process 709 shown in FIG. 7F. At 790, the user A enters, e.g., using vehicle's keypad, a key code. Upon receipt of the entered code, the code may be transmitted to the verification engine 502 for verification, at 792. The verification engine 502 compares the entered code with data that is stored (e.g., in the authentication database 512), at 794, to determine whether there is a match. If match is determined, the verification engine 502 (e.g., through vehicle's various controllers and/or processing components) can unlock the vehicle and/or perform any other action, at 796. Otherwise, the vehicle can remain locked.

Using the process 711, the current subject matter can authenticate users who carry a paper receipt without an access to a mobile device or a mobile application-connected device signed in for a specific user. This process can be especially applicable to deliveries, where retailers loading the vehicle carry a paper receipt only. Here, additional hardware, e.g., a keypad, may be utilized for the purposes of entering the codes.

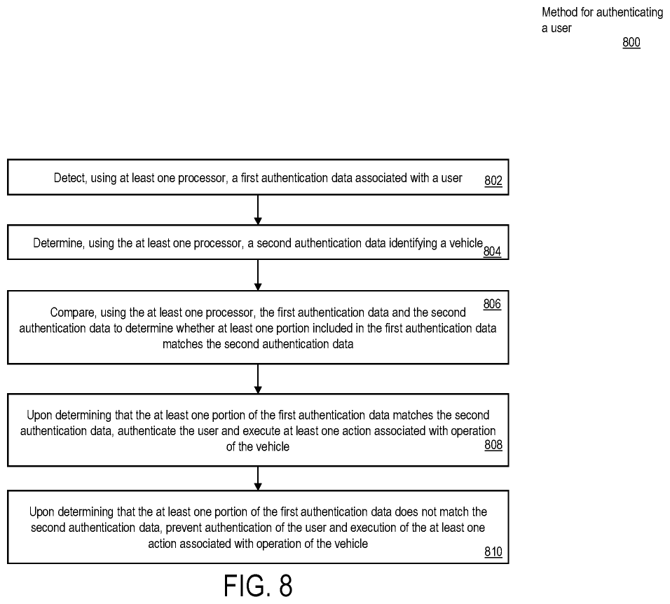

FIG. 8 illustrates an example process 800 for authenticating a user, according to some embodiments of the current subject matter. The process 800 can be executed using one or more components of an autonomous vehicle (e.g., as shown in FIGS. 1-4D, such as, for example, a vehicle's controller, a planner, an AV network, etc., and/or any other components). Alternatively, or in addition, the process 800 can be executed using the verification engine 502 shown in FIG. 5. The verification engine 502 can be a computing component (e.g., a processor, a server, etc.) that can be incorporated into the vehicle's system and/or a separate computing component positioned outside of and communicatively coupled to the vehicle's systems.

At 802, a first authentication data (e.g., QR code, key code, etc.) associated with a user (e.g., user A) is detected by the vehicle. In some embodiments, the detection of the first authentication data is automatically initiated in response to determining that the vehicle arrived in a target region. The detection of the first authentication data can be performed using one or more sensing devices. The detection of the first authentication data can include detecting the first authentication data based on a transmission of the first authentication data from a user device. In some embodiments, the first authentication data is generated using the user device. The sensing device includes at least one of: a camera, a motion sensor, an image capturing device, a scanner, a QR code scanner, a keypad sensing device, and any combination thereof. The sensing device can be positioned on the vehicle. The sensing device can be configured to perform scanning, using at least one sensing device positioned on the vehicle, for the first authentication data. The sensing device can receive an entry of the first authentication data. The first authentication data can include information about a specific task (e.g., order placed by a customer for delivery) and/or the vehicle identifier. The vehicle identifier may correspond to a particular autonomous vehicle, to which the user (e.g., user A) is trying to gain access for the purposes of performing a particular operation (e.g., placing items within a compartment for delivery associated with a placed order). The vehicle identifier (e.g., numerical identifier or alpha-numerical identifier, such as a sequence of multiple alphanumerical entries) may have been assigned from a database (e.g., vehicle database 508 shown in FIG. 5) by another user (e.g., user B shown in FIG. 5).

At 804, a second authentication data (e.g., vehicle identifier) identifying a vehicle is determined. The determination of the second authentication data can be performed by the verification engine 502, where the verification engine 502 can access the second authentication data that is stored in a database (e.g., authentication database 512 shown in FIG. 5). The database can store a plurality of second authentication data, each second authentication data in the plurality of second authentication data identifying a respective vehicle. The database can store the second authentication data as a numerical identifier or an alpha-numerical identifier.

At 806, the verification engine compares the first authentication data and the second authentication data to determine whether at least one portion included in the first authentication data matches the second authentication data. The comparison can include an identification of the first authentication data type (e.g., string input defining a code, biometric data, QR code, image, etc.) and a selection of a matching second authentication data type. In some embodiments, the authentication data matching includes a multiple comparison using different authentication data types. In some embodiments, the matching of authentication data including images and/or QR codes can include a comparison of a first value computed from at least the graphical elements of the image from the received first authentication data, with a second value computed from the second authentication data, whereby the first and second values satisfy a defined correspondence relationship.

At 808, in response to determining that at least one portion of the first authentication data matches the second authentication data, the verification engine 502 authenticates the user and executes at least one action associated with operation of the vehicle (e.g., unlocking trunk, doors, etc.), at 808. The at least one action can include at least one of: unlocking at least one compartment of the vehicle; locking at least one compartment of the vehicle; and executing at least one motion maneuver by the vehicle, wherein the at least one motion maneuver comprises determining at least one: a speed, a position, an acceleration, a direction of movement, a travel destination, and any combination thereof of controlling the movement of the vehicle.

Alternatively, at 810, in response to determining that at least one portion of the first authentication data does not match the second authentication data, the verification engine 502 prevents an execution of the action associated with operation of the vehicle and can request a repetition of the authentication process by returning to 802. For example, the vehicle can remain locked and the user can be prevented from accessing it until the authentication is successful. In some implementations, the example process 800 can be configured to allow a set number (e.g., 3, 4, or 5) of repetitions of the authentication process in response to failed authentications.

The example process 800 provides one or more secure methods for authenticating users for providing access a particular autonomous vehicle. The example process 800 cancan provide a secure access to the autonomous vehicle that is limited to authorized users. The example process 800 can be performed with or without any additional hardware/software computing components (e.g., a mobile device, a mobile application, etc. used for unlocking the vehicle and/or confirming identity of the user). The example process 800 may utilize existing autonomous vehicle's sensors (e.g., cameras, motion sensors, etc.) to authenticate the user. Alternatively, or in addition to, various hardware devices may be positioned on the vehicle for performing authentication.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

What is claimed is:

1. A system comprising:
a verification engine communicatively coupled to a sensing device and a database, the verification engine comprising at least one processor and at least one non-transitory storage media storing instructions that, when executed by the at least one processor, cause the at least one processor to perform operations comprising:
receiving first authentication data based on transmission of the first authentication data by a user device to the sensing device, the first authentication data associated with a vehicle identifier;
retrieving, from the database, second authentication data associated with a stored vehicle identifier, the stored vehicle identifier corresponding to a vehicle comprising the sensing device;
comparing the vehicle identifier to the stored vehicle identifier to determine whether the vehicle identifier matches the stored vehicle identifier;
in a case where the vehicle identifier matches the stored vehicle identifier:
authenticating the user device, and
transmitting data associated with an instruction to provide access to the vehicle based on authenticating the user device, and
in a case where the vehicle identifier does not match the stored vehicle identifier:
transmitting data associated with an instruction to forgo providing access to the vehicle.

2. The system of claim 1, wherein the operations further comprise:
determining that the at least one portion of the first authentication data is different from the second authentication data;
determining that a user authentication is unsuccessful; and
preventing the at least one action associated with the operation of the vehicle.

3. The system of any of the preceding claims, wherein the sensing device is positioned on the vehicle.

4. The system of claim 3, wherein the sensing device comprises at least one of: a camera, a motion sensor, an image capturing device, a scanner, a QR code scanner, a keypad sensing device, and any combination thereof.

5. The system of any of the preceding claims, wherein the sensing device is configured to perform scanning, using at least one sensing device positioned on the vehicle, for the first authentication data.

6. The system of any of the preceding claims, wherein the sensing device receives, using at least one sensing device positioned on the vehicle, an entry of the first authentication data.

7. The system of any of the preceding claims, wherein detecting the first authentication data comprises: detecting the first authentication data based on a transmission of the first authentication data from a user device.

8. The system of any of the preceding claims, wherein the database stores a plurality of second authentication data, each second authentication data in the plurality of second authentication data identifying a respective vehicle.

9. The system of any of the preceding claims, wherein the database stores the second authentication data as a numerical identifier or an alpha-numerical identifier.

10. The system of any of the preceding claims, wherein the first authentication data is generated using at least one user device.

11. The system of any of the preceding claims, wherein the at least one action comprises at least one of:
unlocking at least one compartment of the vehicle;
locking at least one compartment of the vehicle; and
executing at least one motion maneuver by the vehicle, wherein the at least one motion maneuver comprises determining at least one: a speed, a position, an acceleration, a direction of movement, a travel destination, and any combination thereof of controlling the movement of the vehicle.

12. A method comprising:
receiving, using a verification engine and from a detector coupled to a vehicle, a first authentication data associated with a user, the first authentication data comprising a vehicle identifier,
retrieving, using the verification engine and from a database coupled to the vehicle, a second authentication data comprising a stored vehicle identifier,
comparing, using the verification engine, the first authentication data and the second authentication data to determine whether at least one portion of the first authentication data matches the second authentication data;
in response to determining that the at least one portion of the first authentication data matches the second authentication data, selectively authenticating, using the verification engine, the user, and
selectively transmitting, using the verification engine and to a locking component of the vehicle, an instruction for executing at least one action associated with an operation of the vehicle.

13. A non-transitory storage media storing instructions that, when executed by at least one processor, cause the at least one processor to perform operations comprising:
receiving, from a detector coupled to a vehicle, a first authentication data associated with a user, the first authentication data comprising a vehicle identifier,
retrieving, from a database coupled to the vehicle, a second authentication data comprising a stored vehicle identifier,
comparing the first authentication data and the second authentication data to determine whether at least one portion of the first authentication data matches the second authentication data;
in response to determining that the at least one portion of the first authentication data matches the second authentication data, selectively authenticating the user, and selectively transmitting, to a locking component of the vehicle, an instruction for executing at least one action associated with an operation of the vehicle.
